(19) United States
(12) Patent Application Publication
(10) Pub. No.: US 2005/0228851 A1
(43) Pub. Date: Oct. 13, 2005

(54) Configuration of redirection tables

(75) Inventor: Linden Cornett, Portland, OR (US)

Correspondence Address: KONRAD RAYNES & VICTOR, LLP, Suite 210, 315 S. Beverly Drive, Beverly Hills, CA, 90212, US

(73) Assignee: Intel Corporation

(21) Appl. No.: 10/813,334

(22) Filed: Mar. 29, 2004

(51) Int. Cl. G06F 15/00

(52) U.S. Cl. 709/200; 718/100

(57) ABSTRACT

In certain embodiments, a determination is made of a number of conflicting entries in a first redirection table having a first set of entries, wherein the first set of entries is capable of being mapped to a second set of entries of a second redirection table. A mapping is performed of the first set of entries to the second set of entries, based on the number of conflicting entries in the first redirection table.

### BACKGROUND

Receive side scaling (RSS) is a feature in an operating system that allows network adapters that support RSS to direct packets of certain Transmission Control Protocol/Internet Protocol (TCP/IP) flows to be processed on a designated Central Processing Unit (CPU), thus increasing network processing power on computing platforms that have a plurality of processors. Further details of the TCP/IP protocol are described in the publication entitled “Transmission Control Protocol: DARPA Internet Program Protocol Specification,” prepared for the Defense Advanced Projects Research Agency (RFC 793, published September 1981). The RSS feature scales the received traffic across the plurality of processors in order to avoid limiting the receive bandwidth to the processing capabilities of a single processor.

In order to direct packets to the appropriate CPU, a hash function is defined that takes as an input the header information included in the flow, and outputs a hash value used to identify the CPU on which the flow should be processed by a device driver and the TCP/IP stack. The hash function is run across the connection-specific information in each incoming packet header. Based on the hash value, each packet is assigned to a certain bucket in a redirection table. There are a fixed number of buckets in the redirection table and each bucket can point to a specific processor. The contents of the redirection table are pushed down from the host stack. In response to an incoming packet being classified to a certain bucket, the incoming packet can be directed to the processor associated with that bucket.

### BRIEF DESCRIPTION OF THE DRAWINGS

Referring now to the drawings in which like reference numbers represent corresponding parts throughout:

FIG. 1 illustrates a computing environment, in accordance with certain embodiments;

FIG. 2 illustrates a block diagram that shows how packets are distributed among a plurality of processors, in accordance with certain embodiments;

FIG. 3 illustrates a block diagram that shows how a device driver maps a software redirection table to a hardware redirection table, in accordance with certain embodiments;

FIG. 4 illustrates first operations implemented in a device driver that is capable executing in the computing environment, in accordance with certain embodiments;

FIG. 5 illustrates second operations implemented in a device driver that is capable executing in the computing environment, in accordance with certain embodiments;

FIG. 6 illustrates a block diagram that provides an exemplary mapping of packets to processors, in accordance with certain embodiments.

FIG. 7 illustrates a block diagram of a computer architecture for certain elements of the computing environment, in accordance with certain embodiments.

### DETAILED DESCRIPTION

In the following description, reference is made to the accompanying drawings which form a part hereof and which illustrate several embodiments. It is understood that other embodiments may be utilized and structural and operational changes may be made.

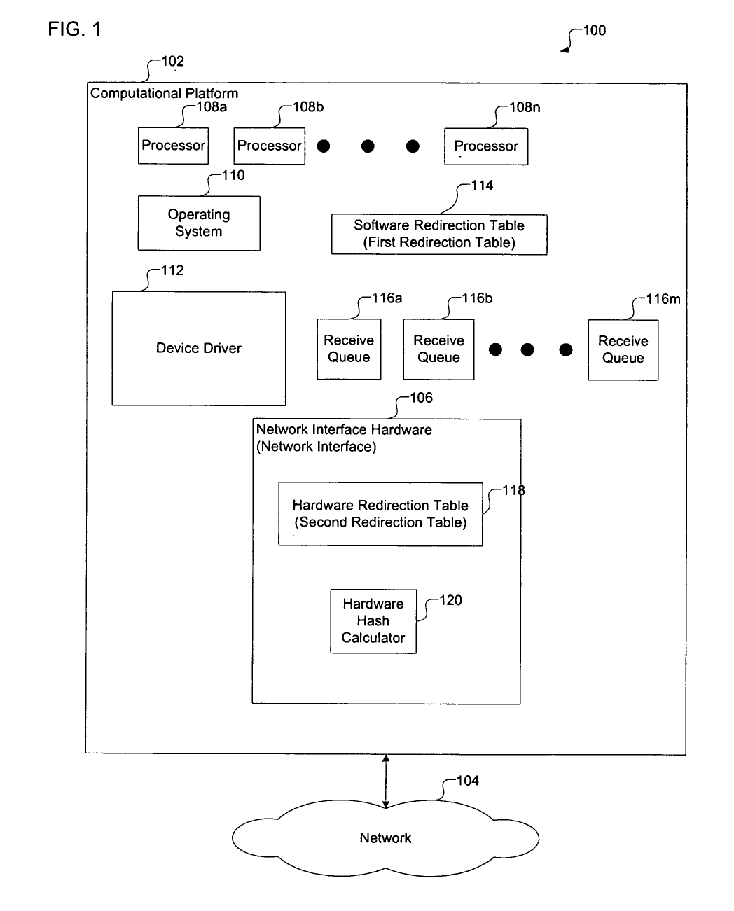

FIG. 1 illustrates a computing environment 100, in accordance with certain embodiments. A computational platform 102 is coupled to a network 104 via a network interface hardware 106. The computational platform 102 may send and receive packets from other devices (not shown) through the network 104.

The computational platform 102 may be a personal computer, a workstation, a server, a mainframe, a hand held computer, a palm top computer, a laptop computer, a telephony device, a network computer, a blade computer, or any other computational platform. The network 104 may comprise the Internet, an intranet, a Local area network (LAN), a Storage area network (SAN), a Wide area network (WAN), a wireless network, etc. The network 104 may be part of one or more larger networks or may be an independent network or may be comprised of multiple interconnected networks. The network interface hardware 106 may send and receive packets over the network 106. In certain embodiments the network interface hardware 106 may include a network adapter, such as, a TCP/IP offload engine (TOE) adapter.

In certain embodiments, the computational platform 102 may comprise a plurality of processors 108a . . . 108n, an operating system 110, a device driver 112, a software redirection table 114, and a plurality of receive queues 116a . . . 116m.

The plurality of processors 108a . . . 108n may comprise Complex Instruction Set Computer (CISC) or Reduced Instruction Set Computer (RISC) processors or any other processor. The Operating system 110 may comprise the MICROSOFT WINDOWS® Operating System, the UNIX* operating system, or other operating system. The device driver 112 may be a device driver for the network interface hardware 104. For example, in certain embodiments if the network interface hardware 104 is a network adapter then the device driver 112 may be a device driver for the network adapter.

The software redirection table 114 is a data structure that includes a plurality of entries, where each entry may be used to point to one of the plurality of processors 108a . . . 108n where received packets may be processed. In certain embodiments, the software redirection table 114 may be part of the operating system 110 or may be otherwise be associated with the operating system 110.

The receive queues 116a . . . 116m are data structures that are managed by the device driver 112. Receive queues 116a . . . 116m may include packets received by the network interface hardware 106 that are queued for processing by the processors 108a . . . 108n.

The network interface hardware 106 may include a hardware redirection table 118 and a hardware hash calculator 120. In certain embodiments, the hardware redirection table 118 may be implemented in hardware in the network interface hardware 106, and each entry in the hardware redirection table may be used to point to one of the plurality of processors 108a . . . 108n where received packets may be processed.

The hardware hash calculator 120 may compute a hash function based on the header of a received packet, where the hash function maps to an entry of the hardware redirection table 118. In certain embodiments, the received packet may be processed by a processor that corresponds to the entry mapped onto by the hash function.

In certain embodiments, the software redirection table 114 may have a different number of entries than the hardware redirection table 118. The device driver 112 maps the software redirection table 114 to the hardware redirection table 118 and directs received packets to the processors 108a . . . 108n on the basis of the mapping.

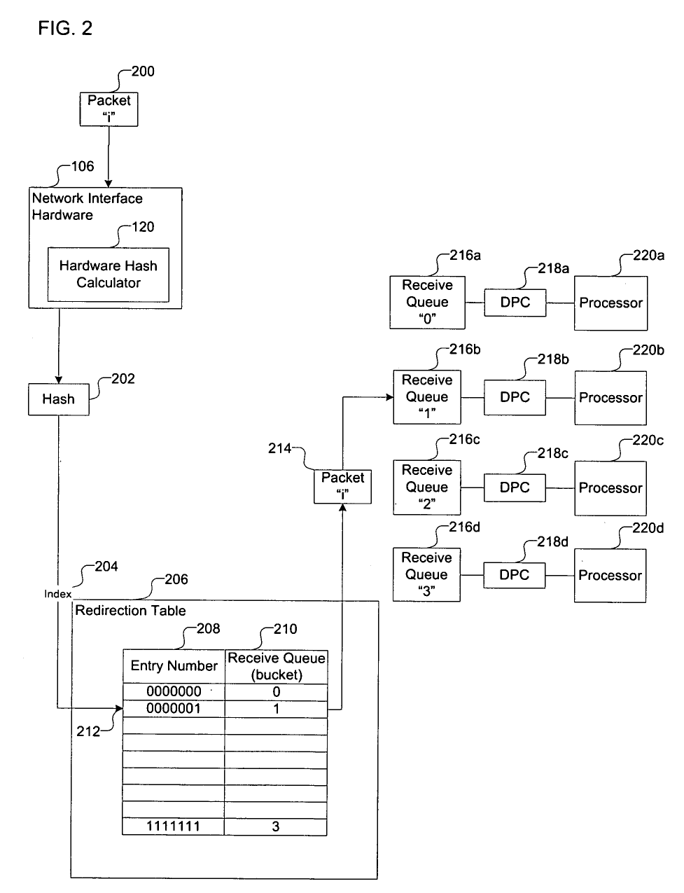

FIG. 2 illustrates a block diagram that shows how packets are distributed among a plurality of processors, in accordance with certain exemplary embodiments implemented in the computing environment 100.

The network interface hardware 106 receives a packet “i” 200 from the network 104. In certain embodiments, the hardware hash calculator 120 applies a hash function to certain headers of the packet “i” 200 to compute a hash 202. The hash 202 may be used to index 204 into an entry of a redirection table 206. The redirection table 206 maps a packet to a receive queue 210 based on which entry number 208 the hash 202 indexes 204 into in the redirection table 206. For example, in certain embodiments the hash 202 may index 204 into the entry number 0000001 (reference numeral 212) that points to the receive queue “1.” In such a case, the packet “i” 214 (which is the same as packet “i” 200) is queued to the receive queue “1” 216b.

In the exemplary embodiment illustrated in FIG. 2, there are four receive queues 216a . . . 216d, four deferred procedure calls (DPC) 218a . . . 218d, and four processors 220a . . . 220m. When the network interface hardware 106 generates an interrupt, the interrupt service routine of the device driver 112 may be called by the operating system 110. The interrupt service routine of the device driver 112 may claim the interrupt, and schedule a DPC. The DPC, when started, may process packets, such as, the packet “i” 200, received by the network interface hardware 106. In certain embodiments, a DPC is used to process packets corresponding to one processor, whereas a receive queue may have a plurality of DPCs associated with the receive queue. In the exemplary embodiment illustrated in FIG. 2, there is one DPC per receive queue. For example, receive queue “1” 216b is associated with DPC 218b that processes packet “i” 214 in the processor 220b.

In the exemplary embodiment illustrated in FIG. 2, the packet “i” 200, 214 is mapped onto the receive queue “1” (reference numeral 216b). The DPC 218b associated with the receive queue “1” (reference numeral 216b) processes the packet 200, 214 in processor 220b.

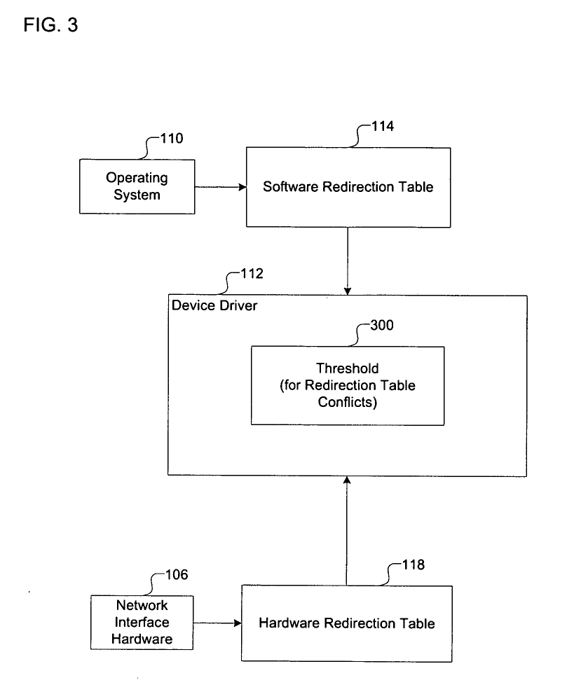

FIG. 3 illustrates a block diagram that shows how the device driver 112 maps the software redirection table 114 to the hardware redirection table 118, in accordance with certain embodiments.

In certain embodiments, the operating system 110 may not place any specific limit on the number of entries in the software redirection table 114. Unlike the software redirection table 114, the number of entries in the hardware redirection table 118 may be limited and may be of a fixed size. Therefore, in certain embodiments there may be a plurality of software table entries corresponding to each hardware table entry. As a result, conflicts may be caused among the software table entries that are to be mapped to the hardware table entries.

For example, if the software redirection table 114 has twice the number of entries as the hardware redirection table 118, then a conflict may present for an entry number x, for which the receive queue corresponding to the entry number x is not the same the receive queue corresponding to the entry number x+N, where N is the number of entries in the hardware redirection table 118. When there is a conflict among the multiple software table entries, the device driver 112 may need to determine which processor to use in the corresponding hardware table entry. In one approach, a heuristic may be used to guess which processor to use in the case of a conflict. Using a heuristic may cause every receive queue to potentially include packets destined for every processor, in the worst case. Therefore, each receive queue may need to have DPCs that correspond to the number of processors. If there are four processors and four receive queues then sixteen DPCs may be necessary in such a heuristic based embodiment. The overhead generated with the creation and usage of a large number of DPCs may reduce system performance.

In certain embodiments, the device driver 112 is provided with a threshold 300. The threshold 300 may be a programmable variable or a constant. In certain embodiments, the device driver 112 determines the number of conflicts in the software redirection table 114 and maps the entries of the software redirection table 114 to the entries of the hardware redirection table 118 based on the number of conflicts.

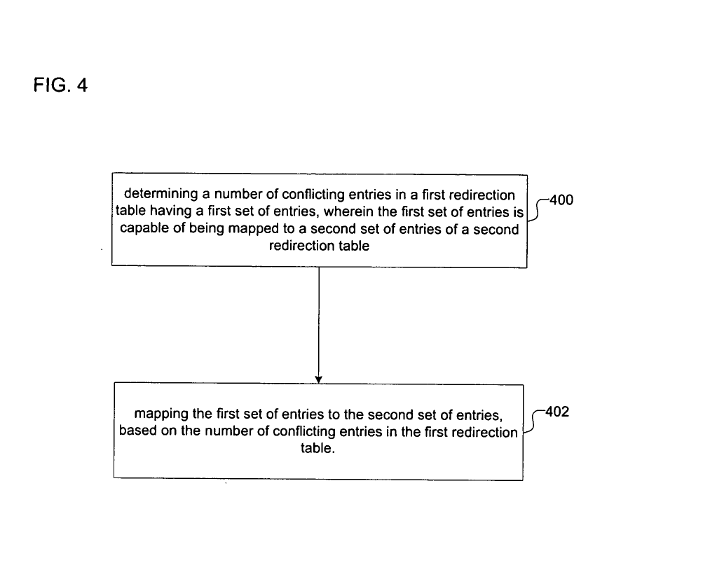

FIG. 4 illustrates first operations implemented in the device driver 112 that is capable executing in the computing environment 100, in accordance with certain embodiments. The device driver 112 maps the entries of the software redirection table 114 to the hardware redirection table 118 based on the number of conflicts in the software redirection table entries.

Control starts at block 400, where the device driver 112 determines a number of conflicting entries in a first redirection table 114 having a first set of entries, wherein the first set of entries is capable of being mapped to a second set of entries of a second redirection table 118. For example, in certain exemplary embodiments, the first redirection table 114 may be the software redirection table 114 and the second redirection table 118 may be the hardware redirection table 118. Additionally, in certain exemplary embodiments the number of entries in the first redirection table 114 may be more than the number of entries in the second redirection table 118. Therefore, in certain exemplary embodiments there may be conflicting entries when more than one entry of the first redirection table 114 is capable of being mapped to a single entry of the second redirection table 118.

The device driver maps (at block 402) the first set of entries to the second set of entries based on the number of conflicting entries in the first redirection table 114. In certain exemplary embodiments, if the number of conflicting entries exceed the threshold 300 then the mapping is performed differently when compared to the case where the number of conflicting entries do not exceed the threshold.

In certain exemplary embodiments, the device driver 112 may map a greater number of entries of the software redirection table 114 to a fewer number of entries of the hardware redirection table 118 based on the number of conflicting entries in the software redirection table 114.

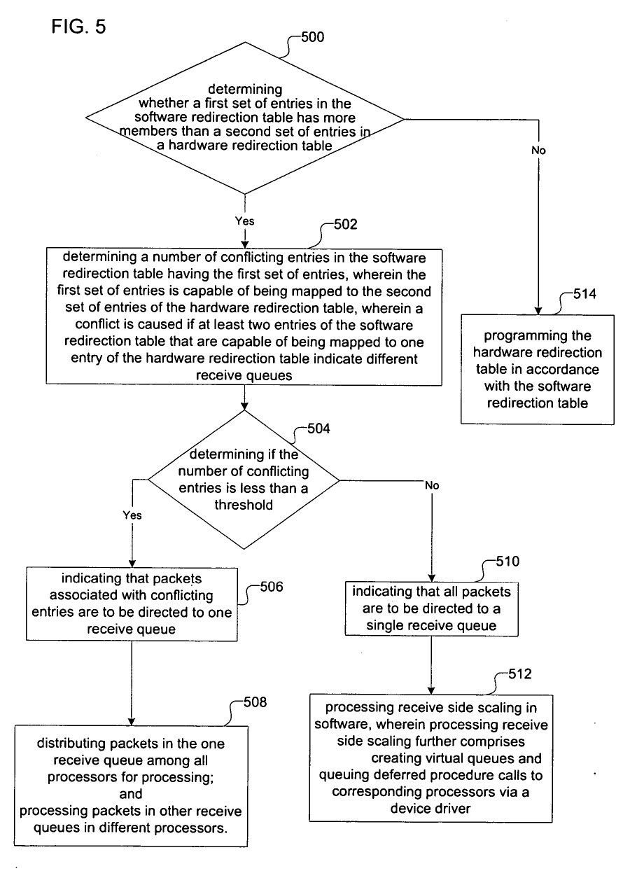

FIG. 5 illustrates second operations implemented in the device driver 112 that is capable of executing in the computing environment 100, in accordance with certain embodiments. In certain exemplary embodiments, the second operations illustrated in FIG. 5 may be performed in addition to the first operations illustrated in FIG. 4, where the first redirection table 114 is a software redirection table 114 and the second redirection table 118 is a hardware redirection table 118. FIG. 5 illustrates operations in which the device driver 112 maps the entries of the software redirection table 114 to the hardware redirection table 118 based on the number of conflicts in the software redirection table entries.

Control starts at block 500, where the device driver 112 determines whether the software redirection table 114 has more entries than the hardware redirection table 118, i.e., whether a first set of entries in the software redirection table 114 has more members than a second set of entries in the hardware redirection table 118. For receive side scaling, each entry is expected to correspond to a receive queue in which the device driver 112 is expected to process a packet. For example, in FIG. 2 the entry denoted by entry number 0000001 (reference numeral 212) corresponds to the receive queue “1”. The device driver 112 is expected to the map the entries of the software redirection table 114 to the entries of the hardware redirection table 118. In certain embodiments, the operating system 110 may provide the software redirection table 114 to the device driver 112 for the network interface hardware 106 that includes the hardware redirection table 118.

In response to determining that the software redirection table 114 has more entries than the hardware redirection table 118, the device driver 114 determines (at block 502) a number of conflicting entries in the software redirection table 114, wherein a conflict is caused if at least two entries of the software redirection table that are capable of being mapped to one entry of the hardware redirection table indicate different receive queues.

The device driver 112 determines (at block 504) whether the number of conflicts is less than the threshold 300. If so, the device driver 112 indicates (at block 506) that packets associated with conflicting entries are to be directed to one receive queue. The device driver 112 distributes (at block 508) packets in the one receive queue among all processors for processing and processes packets in other receive queues in different processors. For example, in certain embodiments if there are four processors numbered “0”, “1”, “2”, “3”, and four receive queues numbered “0”, “1”, “2”, “3”, then all packets associated with conflicting entries may be directed to the receive queue “0”. In this case, queues “1”, “2”, “3” may indicate packets to be processed on processors “1”, “2”, “3” respectively, whereas receive queue “0” may indicate packets to be distributed for processing among processors “0”, “2”, “3”. Therefore, in certain embodiments a total of seven DPCs may be required, where receive queue “0” requires four DPCs and the each of the other receive queues require one DPC. Therefore, when compared to the heuristic based embodiment described earlier, the total number of DPCs are reduced from sixteen to seven.

If a determination (at block 504) is made that the number of conflicting entries is not less than the threshold 300, then the device driver 112 indicates (at block 510) that all packets are to be directed to a single receive queue. When the number of conflicting entries is not less than the threshold, there may be a high number of conflicting entries. In such a case, if the device driver 112 indicates that packets associated with the conflicting entries are to be directed to one receive queue, then the device driver 112 may still be required to process the other receive queues. With a high number of conflicting entries most of packets may be directed to the one receive queue. Therefore, processing overhead may be reduced by having only a single receive queue and directing all packets to the single receive queue. In such a case, in certain exemplary embodiments, four processors and a single receive queue may require only four DPCs.

The device driver 112 processes (at block 512) receive side scaling in software, wherein processing receive side scaling further comprises creating virtual queues and queuing DPCs to corresponding processors via the device driver 112.

If the device deriver determines (at block 500) that the software redirection table 114 does not have more entries than the hardware redirection table 118 then the device driver 112 programs the hardware redirection table 118 in accordance with the software redirection table 114. For each entry of the hardware redirection table 118, the corresponding value in the software redirection table 114 is used. In such a case, if there are four processors then four DPCs may be necessary.

Therefore, FIG. 5 describes an embodiment in which depending on the number of conflicts the device driver 112 maps the software redirection table 114 entries differently to generate the hardware redirection table 118 entries. In certain embodiments, determining whether the software redirection table 114 has more entries, determining the number of conflicts, and indicating are performed by the device driver 112 in the computational platform 102 having the plurality of processors 108a . . . 108n. In certain embodiments, the hardware redirection table 118 is implemented in a hardware device coupled to the computational platform 102 having the plurality of processors 108a . . . 108n, where the hardware redirection table 118 is of a fixed size, and where the software redirection table 114 is associated with the operating system 110 is implemented in the computational platform 102.

In alternative embodiments, the threshold 300 may be compared to conditions that are different from those described in FIG. 5 and the number of conflicting entries may be calculated differently.

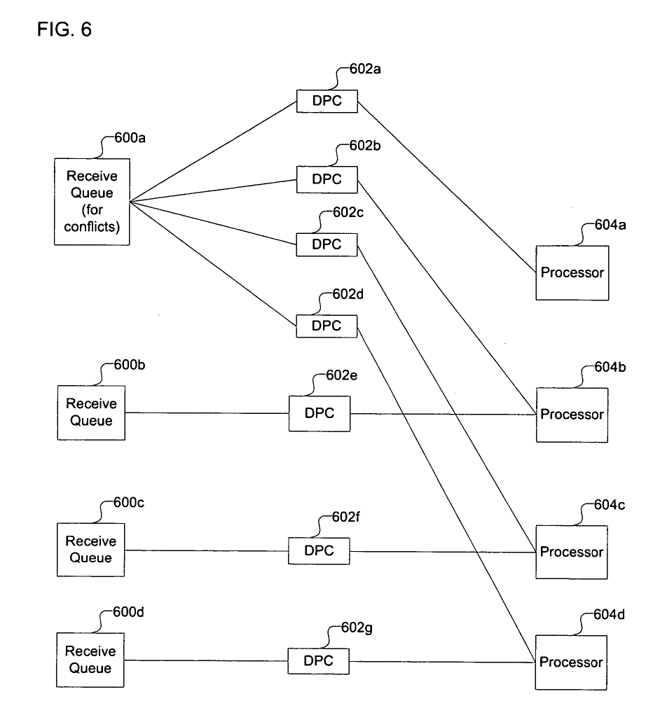

FIG. 6 illustrates a block diagram that provides an exemplary mapping of packets to processors that may be implemented in the computing environment 100, in accordance with certain embodiments.

In FIG. 6 four receive queues 600a . . . 600d are shown. The received packets may be distributed among four processors 604a . . . 604d. If the software redirection table 114 has more entries than the hardware redirection table 118, and the number of conflicts is less than the threshold 300 then in the exemplary embodiment illustrated in FIG. 6, the device driver 112 indicates that packets associated with conflicting entries are to be directed to one receive queue 600a. Therefore, there are four DPCs 602a . . . 602d associated with the receive queue 600a, whereas for each of the other receive queues 600b . . . 600d there are corresponding DPCs 602e . . . 602g. All packets sent to receive queue 600b are processed in processor 604b, all packets sent to receive queue 600c are processed in processor 604c, all packets sent to receive queue 600d are processed in processor 604d, and all packets set to receive queue 600a are distributed among the four processors 604a . . . 604d.

Certain embodiments analyze the characteristics of the software and hardware redirection tables and based on the characteristics map the software redirection table 114 to the hardware redirection table 118. In certain embodiments the number of DPCs that are required are controlled while at the same time the processing of packets are distributed among the processors. In certain other embodiments where the number of conflicts exceed or equal a threshold, receive side scaling is performed in software by the device driver 112 by directing all packets to a single receive queue. In such a case, the number of DPCs may be equal to the number of processors. The overhead associated with the creation of DPCs are controlled in certain embodiments.

The described techniques may be implemented as a method, apparatus or article of manufacture involving software, firmware, micro-code, hardware and/or any combination thereof. The term “article of manufacture” as used herein refers to program instructions, code and/or logic implemented in circuitry (e.g., an integrated circuit chip, Programmable Gate Array (PGA), ASIC, etc.) and/or a computer readable medium (e.g., magnetic storage medium, such as hard disk drive, floppy disk, tape), optical storage (e.g., CD-ROM, DVD-ROM, optical disk, etc.), volatile and non-volatile memory device (e.g., Electrically Erasable Programmable Read Only Memory (EEPROM), Read Only Memory (ROM), Programmable Read Only Memory (PROM), Random Access Memory (RAM), Dynamic Random Access Memory (DRAM), Static Random Access Memory (SRAM), flash, firmware, programmable logic, etc.). Code in the computer readable medium may be accessed and executed by a machine, such as, a processor. In certain embodiments, the code in which embodiments are made may further be accessible through a transmission medium or from a file server via a network. In such cases, the article of manufacture in which the code is implemented may comprise a transmission medium, such as a network transmission line, wireless transmission media, signals propagating through space, radio waves, infrared signals, etc. Of course, those skilled in the art will recognize that many modifications may be made without departing from the scope of the embodiments, and that the article of manufacture may comprise any information bearing medium known in the art. For example, the article of manufacture comprises a storage medium having stored therein instructions that when executed by a machine results in operations being performed. Furthermore, program logic that includes code may be implemented in hardware, software, firmware or many combination thereof.

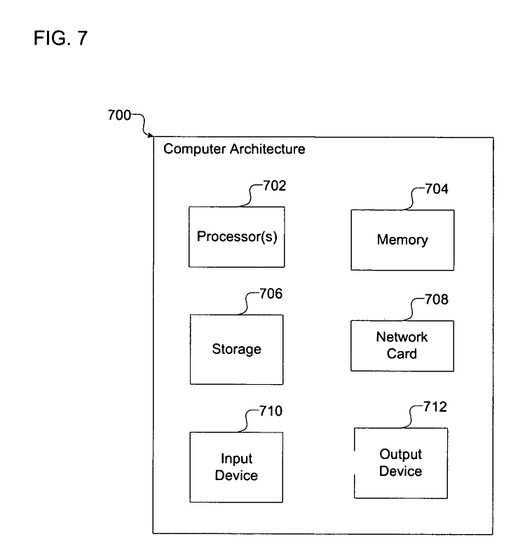

FIG. 7 illustrates a block diagram of a computer architecture in which certain embodiments are implemented. FIG. 7 illustrates one embodiment of the computational platform 102 and the network interface hardware 106. The computational platform 102 and the network interface hardware 106 may implement a computer architecture 700 having one or more processors 702, a memory 704 (e.g., a volatile memory device), and storage 706. Not all elements of the computer architecture 700 may be found in the computational platform 102 and the network interface hardware 106. The storage 706 may include a non-volatile memory device (e.g., EEPROM, ROM, PROM, RAM, DRAM, SRAM, flash, firmware, programmable logic, etc.), magnetic disk drive, optical disk drive, tape drive, etc. The storage 706 may comprise an internal storage device, an attached storage device and/or a network accessible storage device. Programs in the storage 706 may be loaded into the memory 704 and executed by the one or more processors 702 in a manner known in the art. The architecture may further include a network card 708, such as the network interface hardware 106, to enable communication with a network. The architecture may also include at least one input device 710, such as a keyboard, a touchscreen, a pen, voice-activated input, etc., and at least one output device 712, such as a display device, a speaker, a printer, etc.

Certain embodiments may be implemented in a computer system including a video controller to render information to display on a monitor coupled to the computer system including the network interface hardware 106, where the computer system may comprise a desktop, workstation, server, mainframe, laptop, handheld computer, etc. An operating system may be capable of execution by the computer system, and the video controller may render graphics output via interactions with the operating system. Alternatively, some embodiments may be implemented in a computer system that does not include a video controller, such as a switch, router, etc. Furthermore, in certain embodiments the device may be included in a card coupled to a computer system or on a motherboard of a computer system.

At least certain of the operations of FIGS. 4 and 5 can be performed in parallel as well as sequentially. In alternative embodiments, certain of the operations may be performed in a different order, modified or removed. In alternative embodiments, the operations of FIGS. 4, and 5 may be implemented in the network interface hardware 106. Furthermore, many of the software and hardware components have been described in separate modules for purposes of illustration. Such components may be integrated into a fewer number of components or divided into a larger number of components. Additionally, certain operations described as performed by a specific component may be performed by other components.

The data structures and components shown or referred to in FIGS. 1-7 are described as having specific types of information. In alternative embodiments, the data structures and components may be structured differently and have fewer, more or different fields or different functions than those shown or referred to in the figures.

Therefore, the foregoing description of the embodiments has been presented for the purposes of illustration and description. It is not intended to be exhaustive or to limit the embodiments to the precise form disclosed. Many modifications and variations are possible in light of the above teaching.
MICROSOFT WINDOWS is a trademark of Microsoft Corp.
UNIX is a trademark of the Open Group.

1. A method, comprising:
determining a number of conflicting entries in a first redirection table having a first set of entries, wherein the first set of entries is capable of being mapped to a second set of entries of a second redirection table; and
mapping the first set of entries to the second set of entries, based on the number of conflicting entries in the first redirection table.

2. The method of claim 1, wherein the first redirection table is a software redirection table, wherein the second redirection table is a hardware redirection table, and wherein a conflict is caused if at least two entries of the software redirection table that are capable of being mapped to one entry of the hardware redirection table indicate different receive queues, the method further comprising:
determining whether the first set of entries in the software redirection table has more members than the second set of entries in the hardware redirection table, wherein the number of conflicting entries are determined in response to determining that the first set of entries in the software redirection table has more members than the second set of entries in the hardware redirection table; and
indicating that packets associated with conflicting entries are to be directed to one receive queue, in response to determining that the number of conflicting entries is less than a threshold.

3. The method of claim 2, further comprising:
distributing packets in the one receive queue among all processors for processing; and
processing packets in other receive queues in different processors.

4. The method of claim 2, further comprising:
indicating that all packets are to be directed to a single receive queue, in response to determining that the number of conflicting entries is not less than the threshold.

5. The method of claim 4, further comprising:
processing receive side scaling in software, wherein processing receive side scaling further comprises creating virtual queues and queuing deferred procedure calls to corresponding processors via a device driver.

6. The method of claim 2, further comprising:
programming the hardware redirection table in accordance with the software redirection table, in response to determining that the first set of entries in the software redirection table does not have more members than the second set of entries in the hardware redirection table.

7. The method of claim 1, wherein determining and mapping are performed by a device driver in a computational platform having a plurality of processors.

8. The method of claim 1, wherein the first redirection table is associated with an operating system that supports receive side scaling, wherein the second redirection table is implemented in a hardware device coupled to a computational platform having a plurality of processors, and wherein the second redirection table is of a fixed size.

9. A system, comprising:
at least one processor;
a network interface coupled to the at least one processor; and
program logic including code that is capable of causing the at least one processor to be operable to:
(i) determine a number of conflicting entries in a first redirection table having a first set of entries, wherein the first set of entries is capable of being mapped to a second set of entries of a second redirection table implemented in the network interface; and
(ii) map the first set of entries to the second set of entries, based on the number of conflicting entries in the first redirection table.

10. The system of claim 9, wherein the first redirection table is a software redirection table, wherein the second redirection table is a hardware redirection table, and wherein a conflict is caused if at least two entries of the software redirection table that are capable of being mapped to one entry of the hardware redirection table indicate different receive queues, wherein the program logic is further capable of causing the at least one processor to be operable to:
determine whether the first set of entries in the software redirection table has more members than the second set of entries in the hardware redirection table, wherein the number of conflicting entries are determined in response to a determination that the first set of entries in the software redirection table has more members than the second set of entries in the hardware redirection table; and
indicate that packets associated with conflicting entries are to be directed to one receive queue, if the number of conflicting entries is less than a threshold.

11. The system of claim 10, wherein the program logic is further capable of causing the at least one processor to be operable to:
distribute packets in the one receive queue among all processors for processing; and
process packets in other receive queues in different processors.

12. The system of claim 10, wherein the program logic is further capable of causing the at least one processor to be operable to:
indicate that all packets are to be directed to a single receive queue, if the number of conflicting entries is not less than the threshold.

13. The system of claim 12, further comprising:
a device driver, wherein the device driver is operable to process receive side scaling in software by creation of virtual queues, and wherein the device driver is capable of queuing deferred procedure calls associated with the virtual queues to corresponding processors.

14. The system of claim 10, wherein the program logic is further capable of causing the at least one processor to be operable to:
program the hardware redirection table in accordance with the software redirection table, in response to the determination that the first set of entries in the software redirection table does not have more members than the second set of entries in the hardware redirection table.

15. The system of claim 9, further comprising:
a device driver operable to determine the number of conflicting entries and map the first set of entries.

16. The system of claim 9, wherein the first redirection table is associated with an operating system that supports receive side scaling, wherein the second redirection table is implemented in the network interface, and wherein the second redirection table is of a fixed size.

17. A system, comprising:
a computational platform;
a storage controller implemented in the computational platform;
at least one processor coupled to the computational platform;
a network interface coupled to computational platform; and
program logic including code that is capable of causing the at least one processor to be operable to:
(i) determine a number of conflicting entries in a first redirection table having a first set of entries, wherein the first set of entries is capable of being mapped to a second set of entries of a second redirection table, wherein the second redirection table is implemented in the network interface; and
(ii) map the first set of entries to the second set of entries, based on the number of conflicting entries in the first redirection table.

18. The system of claim 17, wherein the first redirection table is a software redirection table, wherein the second redirection table is a hardware redirection table, and wherein a conflict is caused if at least two entries of the software redirection table that are capable of being mapped to one entry of the hardware redirection table indicate different receive queues, wherein the program logic is further capable of causing the at least one processor to be operable to:
determine whether the first set of entries in the software redirection table has more members than the second set of entries in the hardware redirection table, wherein the number of conflicting entries are determined in response to a determination that the first set of entries in the software redirection table has more members than the second set of entries in the hardware redirection table; and
indicate that packets associated with conflicting entries are to be directed to one receive queue, if the number of conflicting entries is less than a threshold.

19. The system of claim 18, wherein the program logic is further capable of causing the at least one processor to be operable to:
distribute packets in the one receive queue among all processors for processing; and
process packets in other receive queues in different processors.

20. The system of claim 18, wherein the program logic is further capable of causing the at least one processor to be operable to:
indicate that all packets are to be directed to a single receive queue, in response to the determination that the number of conflicting entries is not less than the threshold.

21. An article of manufacture, comprising a storage medium having stored therein instructions that are operable by a machine to:
determine a number of conflicting entries in a first redirection table having a first set of entries, wherein the first set of entries is capable of being mapped to a second set of entries of a second redirection table; and
map the first set of entries to the second set of entries, based on the number of conflicting entries in the first redirection table.

22. The article of manufacture of claim 21, wherein the first redirection table is a software redirection table, wherein the second redirection table is a hardware redirection table, and wherein a conflict is caused if at least two entries of the software redirection table that are capable of being mapped to one entry of the hardware redirection table indicate different receive queues, wherein the instructions are further operable by a machine to:
determine whether the first set of entries in the software redirection table has more members than the second set of entries in the hardware redirection table, wherein the number of conflicting entries are determined in response to determining that the first set of entries in the software redirection table has more members than the second set of entries in the hardware redirection table; and
indicate that packets associated with conflicting entries are to be directed to one receive queue, in response to determining that the number of conflicting entries is less than a threshold.

23. The article of manufacture of claim 22, wherein the instructions are further operable by a machine to:
distribute packets in the one receive queue among all processors for processing; and
process packets in other receive queues in different processors.

24. The article of manufacture of claim 22, wherein the instructions are further operable by a machine to:
indicate that all packets are to be directed to a single receive queue, in response to determining that the number of conflicting entries is not less than the threshold.

25. The article of manufacture of claim 24, wherein the instructions are further operable by a machine to:
process receive side scaling in by creation of virtual queues, wherein a device driver is capable of queuing deferred procedure calls associated with the virtual queues to corresponding processors.

26. The article of manufacture of claim 22, wherein the instructions are further operable by a machine to:
program the hardware redirection table in accordance with the software redirection table, in response to determining that the first set of entries in the software redirection table does not have more members than the second set of entries in the hardware redirection table.

27. The article of manufacture of claim 21, wherein determination of the number of conflicting entries and mapping the first set of entries are performed by a device driver in a computational platform having a plurality of processors.

28. The article of manufacture of claim 21, wherein the first redirection table is associated with an operating system that supports receive side scaling, wherein the second redirection table is implemented in the network interface, and wherein the second redirection table is of a fixed size.
